(19) United States
(12) Patent Application Publication
(10) Pub. No.: US 2012/0122003 A1
(43) Pub. Date: May 17, 2012

(54) FUEL CELL COOLING SYSTEM OF FUEL CELL FOR VEHICLE

(75) Inventors: Gi Young Nam, Yongin (KR); Chi Myung Kim, Yongin (KR); Haeong Jin Ko, Seoul (KR); Seong Kyun Kim, Seoul (KR); Seung Yong Lee, Yongin (KR); Yun Seok Kim, Yongin (KR)

(73) Assignee: HYUNDAI MOTOR COMPANY, Seoul (KR)

(21) Appl. No.: 13/174,949

(22) Filed: Jul. 1, 2011

(30) Foreign Application Priority Data
Nov. 12, 2010 (KR) 10-2010-0112965

(51) Int. Cl. H01M 8/04

(52) U.S. Cl. 429/437

(57) ABSTRACT

The present invention relates to a fuel cell cooling system for a vehicle comprising: a cooling water circulating loop formed to cool a fuel cell stack where a plurality of fuel cells are stacked. The cooling water circulating loop includes: a plurality of cooling water introducing ports through which cooling water passing through the stack is introduced; a plurality of cooling water discharging ports corresponding to the plurality of cooling water introducing ports and through which the cooling water which has passed through the stack is discharged; and a plurality of cooling water channels connecting the plurality of cooling introducing ports and the plurality of cooling water discharging ports. Notably, cooling water flows in different directions in the plurality of cooling water channels.

### CROSS-REFERENCE TO RELATED APPLICATION

This application claims under 35 U.S.C. §119(a) the benefit of Korean Patent Application No. 10-2010-0112965 filed Nov. 12, 2010, the entire contents of which are incorporated herein by reference.

### BACKGROUND

(a) Technical Field

The present invention relates to a fuel cell cooling system for a vehicle. More particularly, the present invention relates to a fuel cell cooling system for a vehicle that efficiently cools heat generated in the process of producing electric energy in a fuel cell for a vehicle.

(b) Background Art

A fuel cell is a type of power generating apparatus that converts chemical energy contained in a fuel to electric energy by electrochemically reacting the fuel within a fuel cell stack without burning the fuel into heat. Fuel cells not only supply electric power for industry, homes, and vehicles but may also be applied to small-sized electric/electronic products, especially to supply of power to portable devices.

For example, polymer electrolyte membrane fuel cells or proton exchange membrane fuel cells (PEMFCs) have been widely studied as power supply sources for driving vehicles. These fuel cells generally include a membrane electrode assembly (MEA) in which catalyst electrode layers causing electrochemical reactions are attached on opposite sides of an electrolyte membrane through which protons pass. They also have a gas diffusion layer (GDL) for uniformly distributing reaction gases and transferring generated electric energy, a gasket and a coupling mechanism for sealing the reaction gases and cooling water and maintaining a certain coupling pressure, and a bipolar plate for moving the reaction gases and the cooling water through the cells.

In a fuel cell, fuel, e.g., hydrogen and an oxidant, e.g., oxygen (air) are supplied to an anode and a cathode of the MEA through passages of the bipolar plate. Then, hydrogen is supplied to the anode (also referred to as “fuel electrode”, “hydrogen electrode,” or “oxidizing electrode”) and oxygen (or air) is supplied to the cathode (also referred to as “air electrode”, “oxygen electrode,” or “deoxidizing electrode”).

The hydrogen supplied to the anode is resolved into protons (H⁺) and electrons (e⁻) by the catalysts of the electrode layers on the opposite sides of the electrolyte membrane. Then, only the protons are selectively transferred to the cathode through a positive ion exchanging membrane, (e.g., the electrolyte membrane) and the electrons are transferred to the cathode through conductors, (e.g., the GDL) and the bipolar plate at the same time.

In the cathode, the protons supplied through the electrolyte membrane and the electrons transferred through the bipolar plate meet the oxygen of the air supplied to the cathode and cause a reaction which produces water. Due to flow of the protons, the electrons flow through an external wire, thereby producing electric currents.

More specifically, a fuel cell system mounted to a vehicle generally includes a fuel cell stack for generating electric energy, a fuel supply unit for supplying a fuel (hydrogen) to the fuel cell stack, an air supply unit for supplying an oxidant required for an electrochemical reaction, (e.g., air), to the fuel cell stack, and a cooling system for removing reaction heat created in the fuel cell stack to the outside and controlling the operation temperature of the fuel cell stack.

The fuel cell system having the above-mentioned configuration typically generates electricity using an electrochemical reaction of a fuel, e.g., hydrogen and oxygen of air) and discharges heat and water as by-products of the reaction.

This above described fuel cell system produces heat as a by-product of the reaction. In particular, as tens or hundreds of unit fuel cells are generally stacked in the fuel cell stack to generate an output of large capacity required for driving of the fuel cell stack, a cooling system for cooling the stack is inevitably necessary to prevent temperature increases due to the heat generated in the stack.

A fuel cell reaction is accompanied by production of electric power and production of heat and water. However, polymer electrolyte membranes melt above a certain temperature and the transfer efficiency of hydrogen is reduced due to vaporization of moisture inside, thus resulting in damage to the electrolyte membrane and a lower output.

On the other hand, the water produced in the reaction fails to be vaporized below a certain temperature of the fuel cell stack. Thus, when this temperature is reached, an excessive amount of water is condensed to be converted into a liquid state, and thus blocks cathode channels and hampers supply of oxygen, again lowering the overall output of the system. Accordingly, a certain temperature should be maintained for an efficient fuel cell reaction to occur.

To provide for temperature management, a cooling water circulating loop through which cooling water passes by and circulates in the stack is formed using a pump. Attached to the loop is a cooler which operates to maintain a certain temperature.

FIG. 1 illustrates an example of a conventional cooling water circulating loop of a cooling system. In order to cool a fuel cell stack in which a plurality of fuel cells are stacked where MEAs 12 of each of the plurality of fuel cells are stacked between anode bipolar plates 11 and cathode bipolar plates 13, the conventional cooling water circulating loop of FIG. 1 includes cooling water channels 15 formed in the bipolar plates and cooling water manifolds 14 connected to the cooling water channels.

FIG. 2 schematically illustrates that as cooling water flows through the cooling water circulating loop, the temperature of the cooling water is varied, causing a local temperature difference of the fuel cell.

However, as illustrated in FIG. 2, in a conventional cooling water circulating loop, temperature rises through the exchange of heat while the cooling water is passing through the stack, thereby causing a temperature deviation in the stack between a first section where the cooling water is introduced and a second section where the cooling water is discharged. Accordingly, the efficiency and durability of the fuel cell is deteriorated due to a local difference in the power generating efficiency between the first section and the second section.

### SUMMARY OF THE DISCLOSURE

The present invention provides a fuel cell cooling system for a vehicle that reduces a temperature deviation between an inlet and an outlet of a fuel cell cooling system by forming two or more cooling water channels having a first port and a second port and allowing a fluid to flow in different directions in the two or more cooling water channels. Accordingly, the efficiency of the entire fuel cell system in accordance with the illustrative embodiment of the present invention may be decreased as the power generation efficiency of a stack becomes varied due to a temperature difference between a first section and a second section of a cooling passage generated by heat transfer of the cooling water in the stack.

In one aspect, the present invention provides a fuel cell cooling system for a vehicle comprising: a cooling water circulating loop formed to cool a fuel cell stack where a plurality of fuel cells are stacked. The cooling water circulating loop includes: a plurality of cooling water introducing ports through which cooling water passing through the stack is introduced; a plurality of cooling water discharging ports corresponding to the plurality of cooling water introducing ports and through which the cooling water which has passed through the stack is discharged; and a plurality of cooling water channels connecting the plurality of cooling introducing ports and the plurality of cooling water discharging ports. Notably, in this aspect of the present invention, the cooling water flows in different directions in the plurality of cooling water channels.

The cooling water channels may include a first cooling water channel and a second cooling water channel formed such that the cooling water may flow in different directions.

The plurality of cooling water introducing ports may include a first cooling water introducing port connected to the first cooling water channel and a second cooling water introducing port connected to the second cooling water channel. As with the plurality of cooling water introducing ports, the plurality of cooling water discharging ports may include a first cooling water discharging port connected to the first cooling water channel and a second cooling water discharging port connected to the second cooling water channel. To that end, the first cooling water channel and the second cooling water channel may be alternately disposed between adjacent fuel cells. Alternatively, the first cooling water channel and the second cooling water channel may be alternately disposed between a plurality of fuel cell assemblies having a plurality of fuel cells.

In the fuel cell cooling system according to the present invention, the output (performance) and the durability of a stack are improved by reducing a temperature difference between a first section through which cooling water is introduced and a second section through which the cooling water is discharged along the flow direction of the cooling water and thus preventing local reduction of efficiency by providing two more cooling water channels formed such that the cooling water flows in different directions.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 schematically illustrates cooling water channels in a conventional fuel cell cooling system for a vehicle;

FIG. 2 schematically illustrates that a temperature difference is generated in a fuel cell as cooling water flows in the conventional fuel cell cooling system for a vehicle;

FIG. 3 is a conceptual view schematically illustrating cooling water channels in a fuel cell cooling system for a vehicle according to an exemplary embodiment of the present invention;

FIG. 4 illustrates a cooling water introducing line and a cooling water discharging line connected to a fuel cell stack in the fuel cell cooling system for a vehicle according to the exemplary embodiment of the present invention; and

FIGS. 5 and 6 respectively illustrate two cooling water channels formed in different directions in the exemplary embodiment of the present invention.

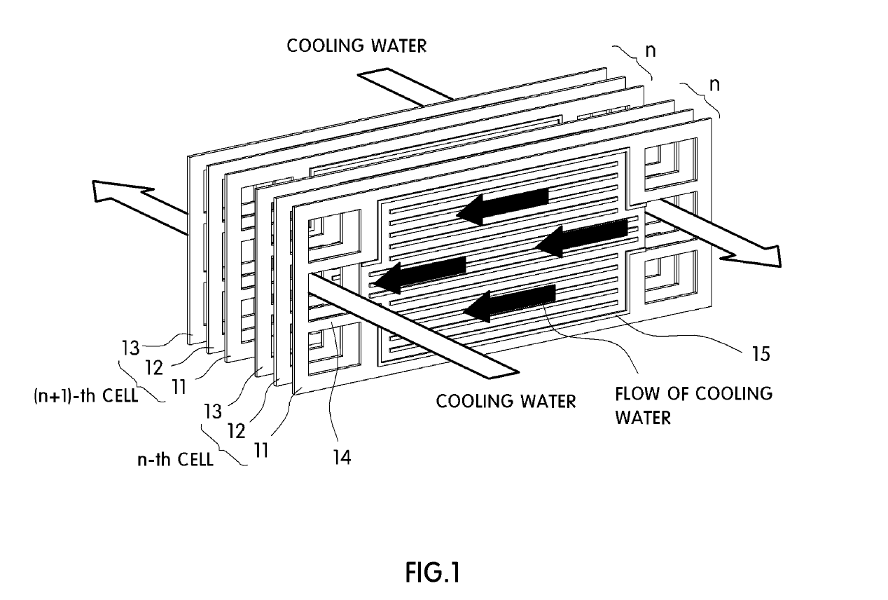

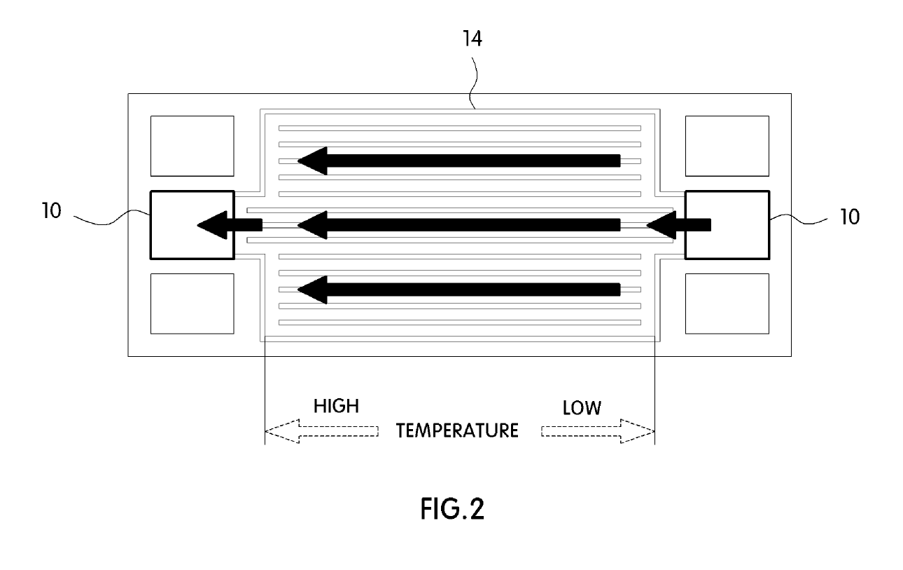

### DETAILED DESCRIPTION

The present invention relates to a cooling system for smoothly cooling a fuel cell system applied to a fuel cell vehicle and provides a detailed structure of cooling passages that reduces a temperature deviation generated when heat of cooling water circulating in a cooling system is exchanged in a stack.

The terms in the subject application are used only to explain specific embodiments, but are not intended to limit the present invention. A singular expression includes a plural expression as long as it definitely has a specific meaning in the context. It should be understood that in the subject application, such terms as “comprise” and “include” are just intended to designate existence of a feature, a number, a step, an operation, an element, a part or a combinations thereof which are described in the specification but are not intended to exclude existence of one or more features, numbers, steps, operations, elements, parts, or combinations thereof, or any possibility of addition.

Furthermore, it is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Generally, the present invention provides a fuel cell cooling system for a vehicle which utilizes a loop formed to cool a fuel cell stack having a plurality of fuel cells. This loop includes a plurality of inlet ports where cooling fluid passing through the stack is introduced to a plurality of channels via the plurality of inlet ports. The loop also includes a plurality of outlet ports corresponding to the plurality of inlet ports. Cooling fluid which has passed through the stack is discharged through the plurality of outlet ports and the plurality of channels connect the plurality of inlet ports and the plurality of outlet ports. In accordance with the following illustrative embodiments of the present invention, the cooling fluid flows in different directions in one or more channels of the plurality channels in the fuel cell stack to thereby allow the effect of heat transfer, realized as the fluid moves across a cell, to be reduced.

Hereinafter, fuel cell cooling systems for a vehicle according to exemplary embodiments of the present invention will be described below in detail with reference to the accompanying drawings such that those skilled in the art to which the present invention pertains can easily practice the present invention.

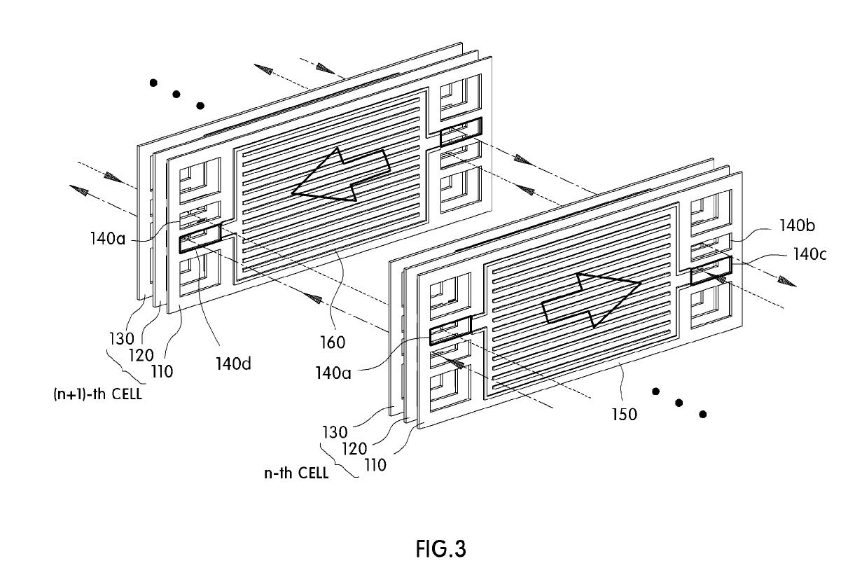

FIG. 3 is a conceptual view schematically illustrating cooling water channels in a fuel cell cooling system for a vehicle according to an exemplary embodiment of the present invention.

As illustrated in FIG. 3, in the fuel cell cooling system for a vehicle according to the present invention, cooling water is circulated through cooling water channels formed in respective fuel cells (or a fuel cell assembly corresponding to a bundle of fuel cells) to cool the respective fuel cells (or the fuel cell assembly).

In particular, according to the illustrative embodiment of the present invention of FIG. 3, a fuel cell cooling system for a vehicle in which cooling water is individually circulated in each fuel cell (e.g., including a stack structure of an anode bipolar plate 110, a membrane electrode assembly (MEA) 120, and a cathode bipolar plate 130) is described in detail.

Referring to FIG. 3, the cooling water circulating loop of the cooling system according to the illustrative embodiment of the present invention includes a plurality of cooling water introducing ports, a plurality of cooling water discharging ports, and cooling water channels 150 and 160 connecting them therewith.

The cooling water introducing ports and the cooling water discharging ports respectively function as introduction openings and discharge openings for cooling water to the cooling water channels 150 and 160. In the illustrative embodiment of the present invention, for example, a pair of introduction and discharge openings corresponds to each cooling water channel respectively.

That is, cooling water is introduced into the cooling water channels 150 and 160 through the cooling water introducing ports. The introduced cooling water then passes through the cooling water channels and is discharged outside the cooling water channels through the cooling water discharging ports. Accordingly, a pair of cooling water introducing port and cooling water discharging port corresponds to one cooling water channel through which cooling water flows in one cooling water circulating loop.

The cooling water introducing ports and the cooling water discharging ports are connected to the cooling water channels 150 and 160 via cooling water manifolds corresponding to the cooling water introducing ports and the cooling water discharging ports respectively.

Referring again to FIG. 3, the cooling water manifolds are disposed on the left and right sides of the fuel cell along the sides of cooling water channels. The cooling water introducing ports and the cooling water discharging ports are formed to allow a fluid communication between the cooling water channels and cooling water manifolds.

In addition, as illustrated in FIG. 3, the flow directions of the cooling water in the cooling water channels may be controlled by determining the cooling water introducing ports and the cooling water discharging ports along introduction/discharge lines of the cooling water. This means that the direction of the flow is determined by the orientation/positioning of the introducing port and discharge port respectively. In doing so, the cooling water introducing ports and the cooling water discharging ports are formed so that the flow of cooling water passing through different consecutive cooling water channels 150 and 160 is set to flow in different directions with respect to the fuel cell.

The flow of cooling water traveling in different directions in alternating channels functions to reduce a temperature deviation within the fuel cell stack by varying a direction along which the temperature gradient of the cooling water rises due to heat transfer in the fuel cell stack.

For example, a cooling water circulating loop of a cooling system may include two different cooling water channels 150 and 160 in which cooling water flows in opposite directions with respect to the fuel cell in the respective cooling water channels.

The embodiment of the present invention is illustrated in detail in FIG. 3.

FIG. 3 illustrates an example of a cooling water circulating loop having two cooling water channels 150 and 160 where the flow directions of each are opposite to each other with respect to a fuel cell. Furthermore, the cooling water circulating loop may include a first cooling water passage which has a first cooling water channel 150 formed in the n-th cell and a second cooling water passage having a second cooling water channel 160 formed in the (n+1)-th cell such that cooling water flows in a direction opposite to the flow direction of the first water cooling passage.

In the first cooling water passage, the cooling water channel is connected to a cooling water manifold through the first cooling water introducing port 140a and the first cooling water discharging port 140c. Further, in the second cooling water passage, the cooling water channel is connected to a cooling water manifold through the first cooling water introducing port 140b and the first cooling water discharging port 140d.

The cooling water manifolds are connected to the cooling water channels thereby allowing cooling water to be introduced into the fuel cell stack or discharged from the fuel cell stack in certain directions. In some embodiments of the present invention, the cooling water manifolds have a rectangular parallelepiped shape formed along the stack direction of the fuel cells.

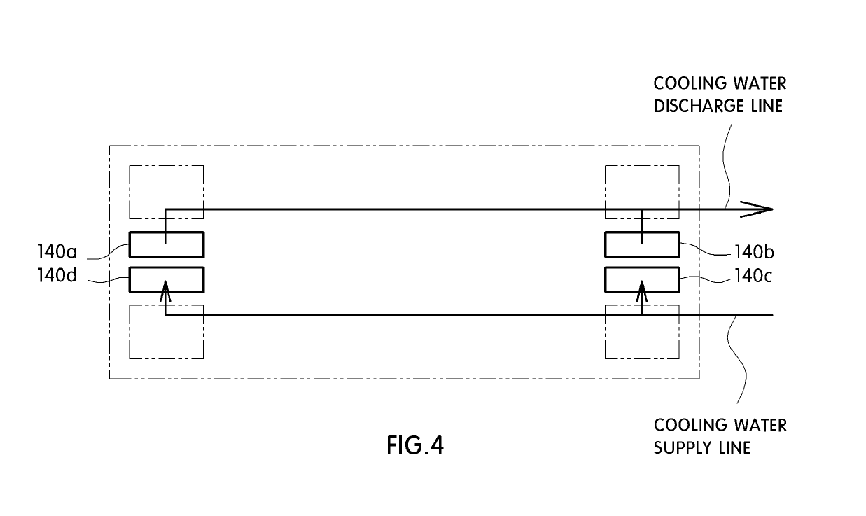

As illustrated in FIG. 4, the cooling water manifold extends along a cooling water supply line or a cooling water discharge line, and the first cooling water introducing port 140a and the second cooling water introducing port 140b are connected to the cooling water supply line in common and the first cooling water discharging port 140c and the second cooling water discharging port 140d are connected to the cooling water discharge line in common.

Thus, the first cooling water passage and the second cooling water passage form a single cooling water circulating loop that is realized by one supply line and one discharge line.

Additionally, although not illustrated in the figures, in the embodiment of the present invention, a plurality of cooling water introducing ports or a plurality of cooling water discharging ports flowing in the same direction may be formed for each cell along the stack direction of the fuel cells with respect to one cooling water manifold.

That is, in the embodiment of FIG. 3, when a plurality of fuel cells are stacked on the front or rear sides of the n-th and (n+1)-th cells, the flows of the cooling water for each respective cell follows the direction of either the first cooling water passage or the second cooling water passage, in which case a plurality of cooling water introducing ports and a plurality of cooling water discharging ports may be formed for respective cooling water channels connected to the same cooling water manifold in a fuel cell stack where a plurality of fuel cells are stacked.

More specifically, in the present invention, the plurality of cooling water introducing ports and a plurality of cooling water discharging ports may be classified according to their flow directions of cooling water without being classified according to the stacked directions, and they are generally referred to as first cooling water introducing/discharging ports or second cooling water introducing/discharging ports.

The flow directions of the cooling water may be set by forming a cooling water introducing port and a cooling water discharging port for a desired flow direction in a cooling water manifold expanded in the stack direction and thus connecting the cooling water manifold to the cooling water channel.

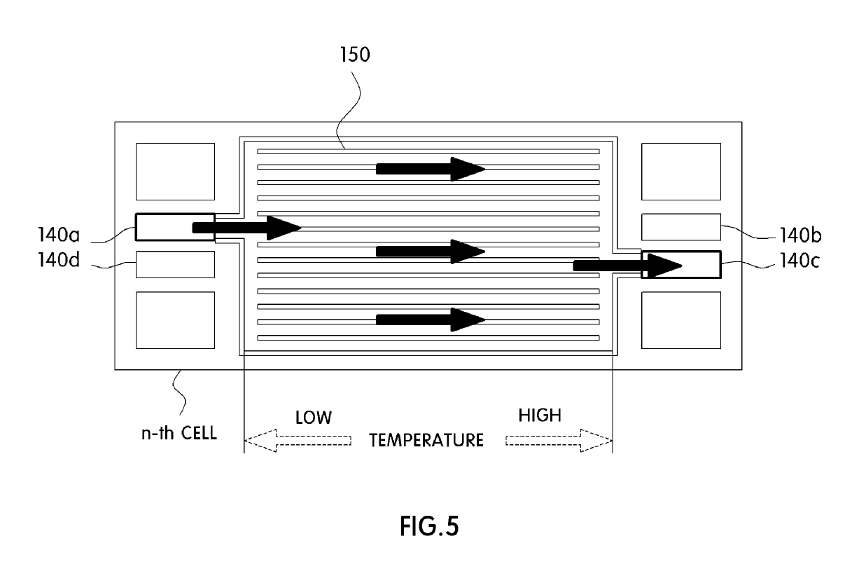

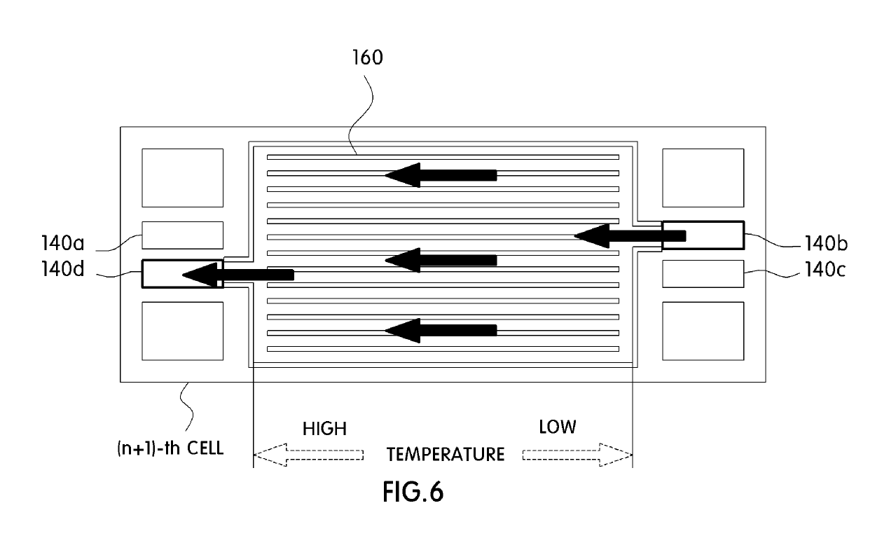

In this connection, FIGS. 5 and 6 illustrate cooling water introducing/discharging ports in the n-th and (n+1)-th cells and detailed flow directions of the cooling water. As can be seen from FIGS. 5 and 6, a first cooling water passage and a second cooling water passage may be selectively disposed in a fuel cell stack to allow the cooling water to flow in different directions in the first and second cooling water passage respectively.

In some embodiments of the present invention, fuel cells having the first cooling water passage and fuel cells having the second cooling water passage are alternately stacked to reduce a temperature deviation across the entire fuel cell stack, however, they may be stacked in any combination so as to achieve a desired cooling effect.

For example, a single cell assembly may be formed by binding a plurality of fuel cells. Accordingly, a fuel cell stack may be formed so that the first cooling water passage and the second cooling water passage are alternately formed between the fuel cell assemblies rather than each fuel cell individually.

In this case, the first cooling water passages are formed in odd-numbered fuel cell assemblies and the second cooling water passages are formed in even-numbered fuel cell assemblies according to stack sequences.

Moreover, although two directional flows in the cooling water channels are disclosed in the embodiments of FIGS. 3 to 5, four pairs of cooling water introducing/discharging ports and cooling water channels may be formed in a fuel cell stack having a rectangular stack cross-section such that four flow directions for respective surfaces of a rectangular shape may be set in the fuel cell stack.

Advantageously, the present invention provides a fuel cell cooling system for a vehicle in which a temperature deviation can be removed by alternating the flow directions of a plurality of cooling water passages in directions thereby offsetting the temperature gradient generated by heat transfer as the cooling water flows through the cooling channels.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents. Further, many modifications may be made to specific situations and materials without departing from the essence of the invention. Therefore, the present invention is not limited to the detailed description of the preferred embodiments but include all embodiments within the scope of the attached claims.

What is claimed is:

1. A fuel cell cooling system for a vehicle comprising:
a cooling water circulating loop formed to cool a fuel cell stack where a plurality of fuel cells are stacked, wherein the cooling water circulating loop includes:
a plurality of cooling water introducing ports wherein cooling water passing through the stack is introduced to a plurality of cooling water channels via the plurality of cooling water introducing ports;
a plurality of cooling water discharging ports corresponding to the plurality of cooling water introducing ports wherein cooling water which has passed through the stack is discharged through the plurality of discharging ports; and
the plurality of cooling water channels connecting the plurality of cooling introducing ports and the plurality of cooling water discharging ports,
wherein the cooling water flows in different directions one or more cooling water channels of the plurality of cooling water channels.

2. The fuel cell cooling system of claim 1, wherein the cooling water channels include a first cooling water channel and a second cooling water channel formed such that the cooling water flows in different directions in each respectively.

3. The fuel cell cooling system of claim 2, wherein the plurality of cooling water introducing ports includes a first cooling water introducing port connected to the first cooling water channel and a second cooling water introducing port connected to the second cooling water channel, and wherein the plurality of cooling water discharging ports include a first cooling water discharging port connected to the first cooling water channel and a second cooling water discharging port connected to the second cooling water channel.

4. The fuel cell cooling system of claim 2, wherein the first cooling water channel and the second cooling water channel are alternately disposed between adjacent fuel cells so that cooling water flowing through each cooling water channel respectively is flowing in opposite directions.

5. The fuel cell cooling system of claim 2, wherein the first cooling water channel and the second cooling water channel are alternately disposed between a plurality of fuel cell assemblies having a plurality of fuel cells so that cooling water flowing through each respectively is flowing in opposite directions.

6. A fuel cell cooling system for a vehicle comprising:
a loop formed to cool a fuel cell stack having a plurality of fuel cells wherein the loop includes:
a plurality of inlet ports wherein cooling fluid passing through the stack is introduced to a plurality of channels via the plurality of inlet ports;
a plurality of outlet ports corresponding to the plurality of inlet ports wherein cooling fluid which has passed through the stack is discharged through the plurality of outlet ports; and
the plurality of channels connecting the plurality of inlet ports and the plurality of outlet ports,
wherein the cooling fluid flows in different directions in one or more channels of the plurality channels in the fuel cell stack.

7. The fuel cell cooling system of claim 6, wherein the cooling water channels include a first channel and a second channel formed such that the cooling fluid flows in different directions in each respectively.

8. The fuel cell cooling system of claim 7, wherein the first channel and the second channel are alternately disposed between adjacent fuel cells so that cooling fluid flowing through each channel respectively is flowing in opposite directions.

9. The fuel cell cooling system of claim 7, wherein the first channel and the second channel are alternately disposed between a plurality of fuel cell assemblies having a plurality of fuel cells so that cooling fluid flowing through each respectively is flowing in opposite directions.

10. The fluid cell cooling system of claim 6 wherein the cooling fluid is water.

11. The fluid cell cooling system of claim 2 wherein flow direction is alternated from one fuel cell to the next within the fuel cell stack, the alternation of the flow direction offsetting the temperature gradient generated by heat transfer as the cooling fluid flows through the cooling channels of the fuel cells in the fuel cell stack.
